(19) United States
(12) Patent Application Publication
(10) Pub. No.: US 2014/0100036 A1
(43) Pub. Date: Apr. 10, 2014

(54) PASS-AROUND WORD GAME APPARATUS AND METHOD OF PLAYING

(71) Applicant: Jeffrey W. Bazarko, Hawthorne, CA (US)

(72) Inventor: Jeffrey W. Bazarko, Hawthorne, CA (US)

(21) Appl. No.: 14/047,432

(22) Filed: Oct. 7, 2013

Related U.S. Application Data
(60) Provisional application No. 61/710,178, filed on Oct. 5, 2012.

(51) Int. Cl. A63F 13/10

(52) U.S. Cl. CPC A63F 13/10
USPC 463/37

(57) ABSTRACT

A game apparatus is provided including a housing. An electronic speaker, electronic display, and at least one input button are coupled to the housing. A controller is electrically coupled to the at least one input button, the electronic display and electronic speaker. The controller is responsive to executable computer instructions for initiating a timer and displaying a first instruction of restrictions of a valid word on the electronic display in response to an actuation of the at least one input button.

### CROSS REFERENCE TO RELATED APPLICATIONS

This application claims the benefit of U.S. Provisional Patent Application Ser. No. 61/710,178, filed Oct. 5, 2012, the contents of which are incorporated herein by reference thereto.

### BACKGROUND

Games are played for entertainment and education. One example of such a game is the word game commonly referred to as the SCRABBLE board game where players score points by forming words on a board.

It is desirable to provide new games, variants of existing games, and methods of playing such games to provide excitement to the users of these games.

### BRIEF SUMMARY OF INVENTION

In one embodiment, a game apparatus is provided including a housing. An electronic speaker, electronic display, and at least one input button are coupled to the housing. A controller is electrically coupled to the at least one input button, the electronic display and electronic speaker. The controller is responsive to executable computer instructions for initiating a timer and displaying a first instruction of restrictions of a valid word on the electronic display in response to an actuation of the at least one input button.

In another embodiment, a method for playing a game using a game apparatus is provided including pressing an input button on the game apparatus. The game apparatus includes a housing, an electronic display and at least one input button coupled to the housing. The game apparatus also includes a controller electrically coupled to the at least one button. A timer is initiated and a first instruction of restrictions of a valid word is received by the electronic display. A first player recites a valid word that conforms with the first instruction of restrictions. The game apparatus is then passed between players such that when each player is in possession of the game apparatus, that player must recite a valid word and again pass the game apparatus. The player in possession of the game apparatus when the timer expires is eliminated.

In yet another embodiment, a method for playing a game using a game apparatus is provided including pressing an input button on the game apparatus. The game apparatus includes a housing and an electronic display and at least one input button coupled to the housing. A controller is electrically coupled to the at least one input button. A first instruction of restriction of a valid word is displayed on the electronic display. Based on the first instruction, a first team challenges a second team to recite a predetermined number of words in a predetermined amount of time. The input button is pressed again to initiate the timer such that the second team recites as many valid words as possible before the timer expires. A point is awarded to the second team if they recited at least as many words as estimated or to the first team if the second team recited fewer words than estimated.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 is a perspective view of a game device in accordance with a first embodiment;

FIG. 2 is a perspective view of the game device in accordance with a second embodiment;

FIG. 3 is a block diagram of the game device of FIG. 1 or FIG. 2;

FIG. 4 is a schematic diagram of the game device of FIG. 1 or FIG. 2;

FIG. 5 is flow diagram illustrating a method of playing the game device of FIG. 1 or FIG. 2 in accordance with an embodiment of the invention; and,

FIG. 6 is a flow diagram illustrating a method of playing the game device of FIG. 1 or FIG. 2 in accordance with another embodiment of the invention.

### DETAILED DESCRIPTION OF THE INVENTION

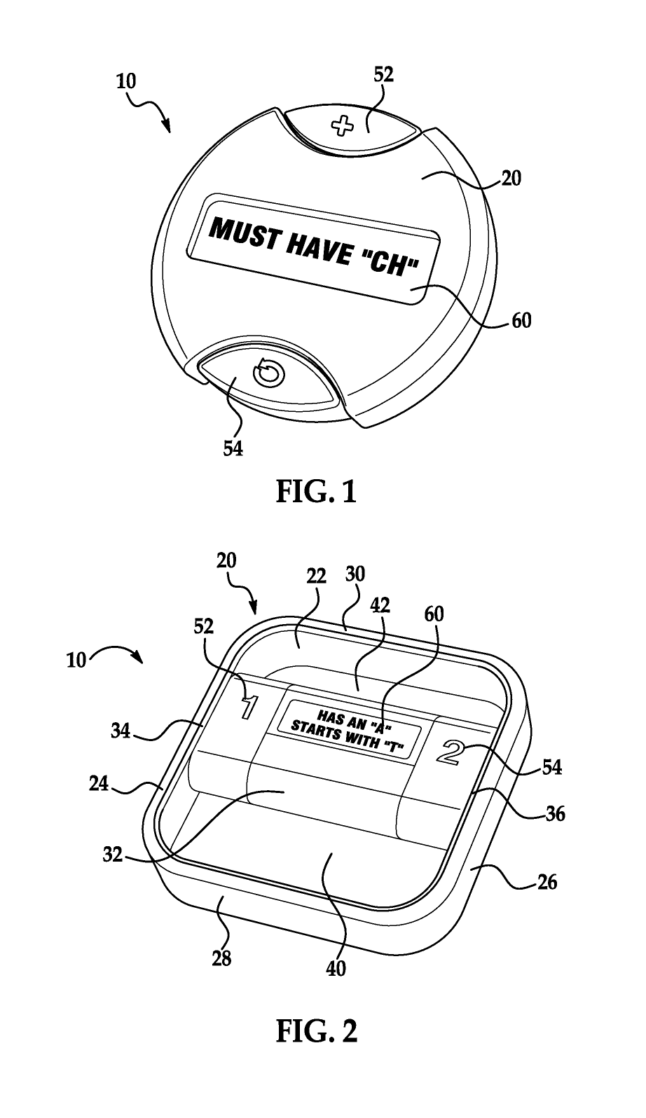

The present invention provides a system and method for enhancing the playing experience for games. FIG. 1 shows an exemplary game apparatus 10 in the process of being played. The game apparatus 10 includes a housing 20 which may be constructed from a molded plastic material. Because the game apparatus 10 is intended to be held by a player participating in the game, a portion of the housing 20 may be sized and shaped to facilitate being held by a person.

The housing 20 protects a plurality of components stored within the housing 20. As illustrated in FIG. 1, the housing may 20 be generally rounded and thin, so as to fit easily within a person's hand. In another embodiment, shown in FIG. 2, the housing 20 includes a generally hollow outer portion 22 within which a central portion 32 is mounted. The central portion 32 is positioned within the outer portion 22 such that a first end 34 of the central portion 32 is connected to a first side 24 of the outer portion and a second, opposite end 36 of the central portion 32 contacts a second, opposite side 26 of the outer portion 22. In one embodiment, the central portion 32 and the outer portion 22 are formed integrally. The outer portion 22 has a length greater than the central portion 32 such that open spaces 40, 42 exist between the central portion 32 and the third side 28 and fourth side 30 of the outer portion 22 respectively. These spaces 40, 42 make the third side 28 and the fourth side 30 of the outer portion 22 easier for a player to grab and hold.

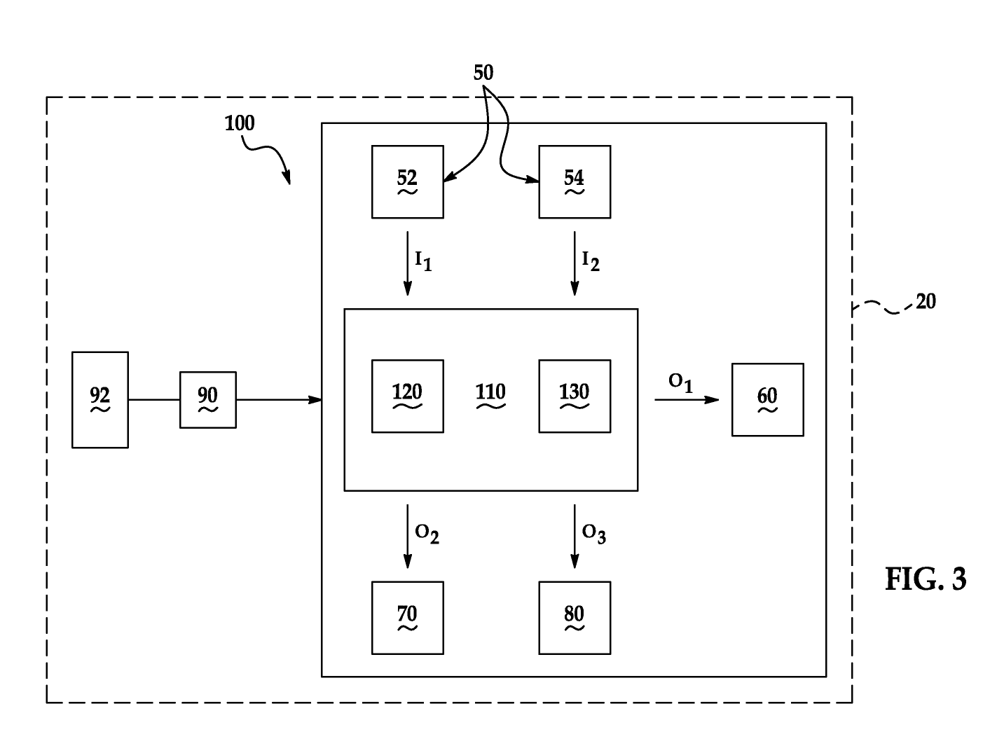

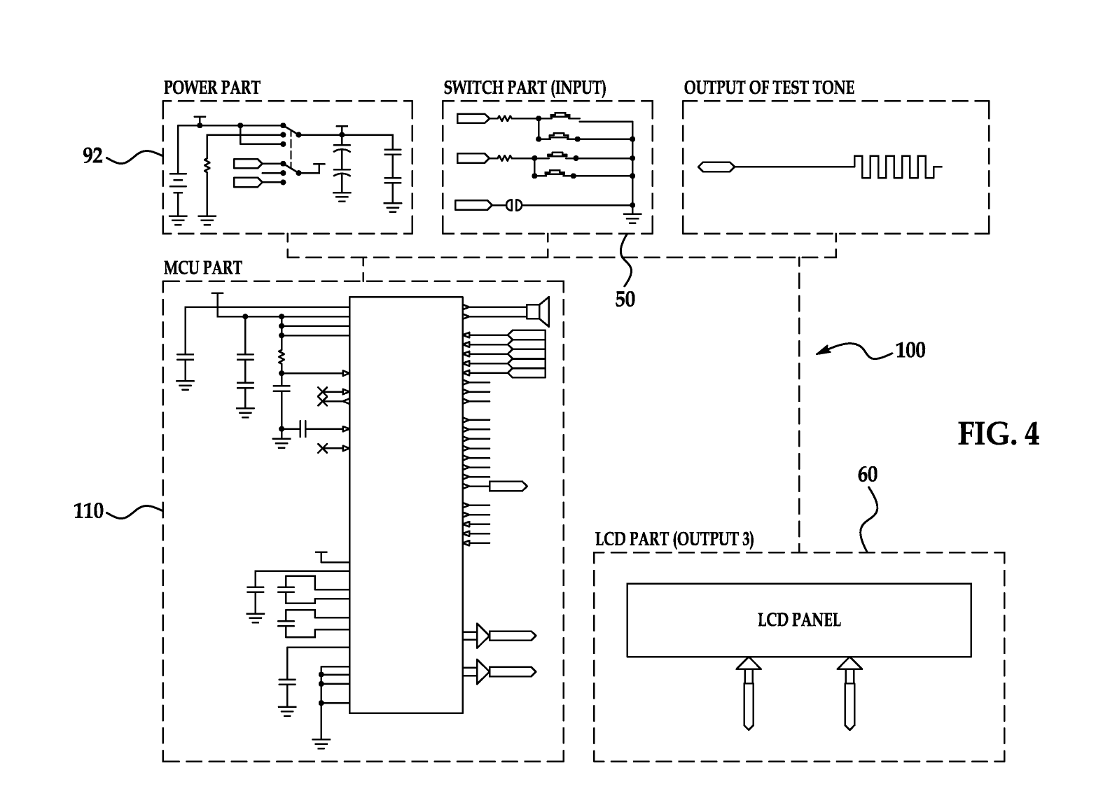

Referring now to FIG. 3, a control system 100 including a controller 110 is mounted within the housing 20 and controls the operation of the handheld game apparatus 10. Another representation of a portion of the control system 100 is illustrated in FIG. 4. In the exemplary embodiment, the game apparatus 10 includes a plurality of input buttons 50, for example a first button 52 and a second button 54 as shown in FIGS. 1 and 2. The input buttons 50 are connected to the controller 110 such that when a force is applied to one of the plurality of input buttons 50, a corresponding input signal I is provided to the controller 110. In some embodiments, the controller 110 includes a timer 120. The controller 110 is responsive to executable computer instructions in response to an actuation of the at least one input button 50 to initiate the timer 120. The timer 120 is configured to run for a predetermined period of time, such as 45 seconds, for example.

An electronic display 60, such as a liquid crystal display (LCD) screen for example, is mounted adjacent or within an opening 21 in the housing 20 so that the electronic display 60 is viewable by a player holding the game apparatus 10. The electronic display 60 is coupled to the controller 110 and is configured to display a command upon receipt of an output signal O₁ from the controller 110. In some non-limiting embodiments, multiple light sources 70, for example light emitting diodes (LEDs), are also coupled to the controller 110. The light sources 70 are configured to illuminate at least a portion of the game apparatus 110 in response to an output signal O₂ from the controller 110. In another embodiment, a speaker 80 is positioned within the housing 20 and receives an output signal O₃ from the controller 110. The speaker 80 is configured to generate sound which is projected to the exterior of the housing 20 through a plurality of holes (not shown) and the volume of the speaker may be adjusted.

The control system 100 may additionally include a storage device 130 having a plurality of stored instructional commands and sound effects. In one embodiment, the plurality of stored commands and sound effects is stored on the storage device in a database. In another embodiment, the plurality of stored commands is stored in the form of a look-up table. Exemplary storage devices include but are not limited to a solid state memory, a flash memory, and a non-volatile memory. The storage device 130 may be integrated with the controller 110, or it may be removably connected to the controller 110 such that it can be replaced, if desired. When the controller 110 receives an input signal I from one of the plurality of input buttons 50, the controller 110 outputs one of the stored commands to the electronic display 60 of the game apparatus 10. In some instances, the stored command may also be output audibly through the speaker 80.

The game apparatus 10 includes a power switch 90 connected to a power source 92, such as a battery for example. The power switch 90 is configured to selectively apply power to the control system 100 of the game apparatus 10. In one embodiment, the power switch 90 is an on/off switch movable between a first “off” position and a second “on” position. In another embodiment, the power switch 90 is an on/off switch movable between a plurality of positions. For example, the on/off switch may be movable between a first “off” position, a second position that selects a “first game mode,” and a third position that selects a “second game mode.” When the power switch 90 is not in an “off” position, power is applied to the control system 100 of the game apparatus 10.

In some embodiments, the handheld game apparatus 10 has a first play mode and a second play mode. To start a game in the first play mode, one of the players moves the power switch 90 from the off position to the on position, thereby energizing the game apparatus 10. When power is initially applied to the control system 100, the controller 110 may output a stored command to the electronic display 60 prompting a player to select the first play mode or the second play mode. Based on the input signal I received from the input button 52, 54 activated by the player, the controller 110 determines which play mode was selected. In other non-limiting embodiments where the power switch 90 is movable between a plurality of “on” positions, the control system 100 of the game apparatus 10 may determine which play mode is selected based on the position of the power switch 90. After determining the play mode, the controller 110 outputs a stored command to the electronic display 60 prompting the player to select a level of difficulty, such as easy or difficult. Based on the input signal I received from the input button 52, 54 activated by the player, the controller 110 will determine what level of difficulty was selected. The level of difficulty selected determines the quantity, type, and combination of commands output while the game is played.

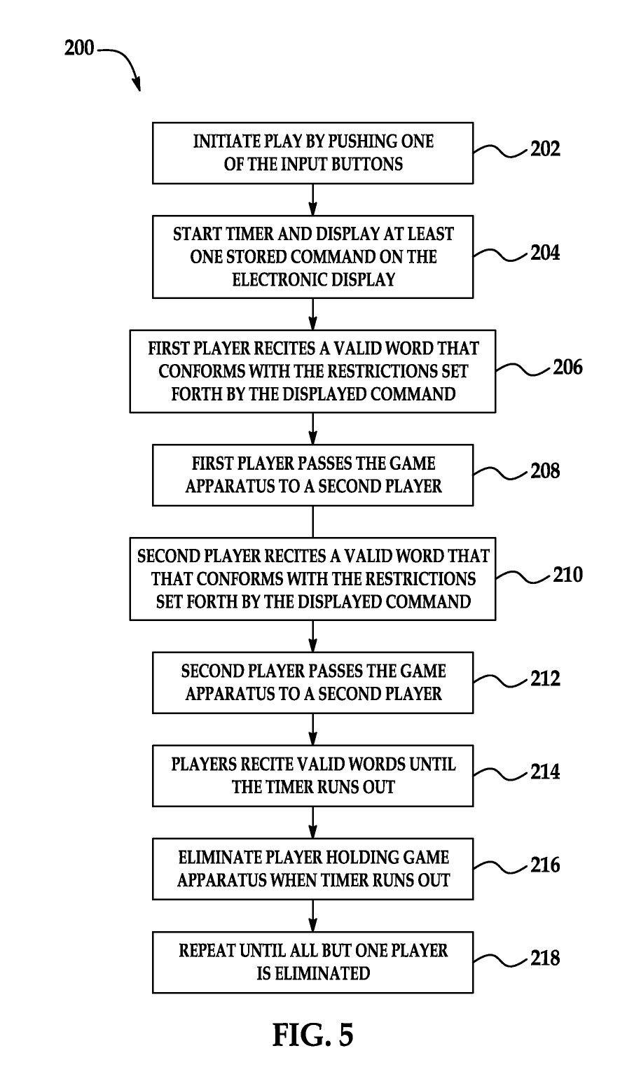

A method 200 of playing a game with the game apparatus 10 in a first mode is illustrated in FIG. 5. After selecting the level of difficulty, a first player holding the game apparatus 10 initiates play in a first play mode by pressing one of the plurality of input buttons 50 on the game apparatus 10, as shown in block 202. In block 204, receipt of the input signal I₁ from the input button 52 starts the timer 120 of the controller 110. A first command stored in the storage device 130 is received by the electronic display 60. The displayed command provides instructions to the player. Each player identifies a word that conforms with the restrictions provided by the displayed command(s). Exemplary commands include that the word “must start with an R” or that the word “must include an EA”, for example. In block 206, the first player speaks a valid word that conforms with the restrictions displayed on the electronic display 60. After a valid word is spoken by the first player, the game apparatus 10 is then passed to a second player, as shown in block 208. Similarly in block 210, the second player speaks a valid word that conforms with the restrictions set forth by the displayed commands. The second player then passes the game apparatus 10 is passed to another player in block 212.

As shown in block 214, the players continue to take turns reciting valid words and passing the game apparatus until the timer 120 runs out. In one embodiment, when the timer 120 runs out, one or more of the plurality of light sources 70 may be operated in a constant and/or flashing manner to identify to the players that the timer 120 has run out and the round is over. In addition, a sound may be output from the controller 110 to the speaker 80. In block 216, the player holding the game apparatus 10 when the timer 120 expires is eliminated from the game. This process is repeated until all but one player has been eliminated, as shown in block 218. In some embodiments, the controller 110 may randomly output additional commands during the game, such as “reverse” or “skip” for example, to the electronic display 60 as well as the speaker 80. When a reverse command is output, the direction that the game apparatus 10 is being passed should reverse. Similarly, when the controller 110 issues a skip command, the game apparatus 10 does not get passed to the next player in the sequence, but instead skips over that player. In other embodiments, the commands include “pass” and “double dare”. An output of “pass” may permit the player holding the device to pass the device to the next player without having to speak a valid word. An output of “double dare” may indicate that the player currently holding the device must say two valid words before passing the device.

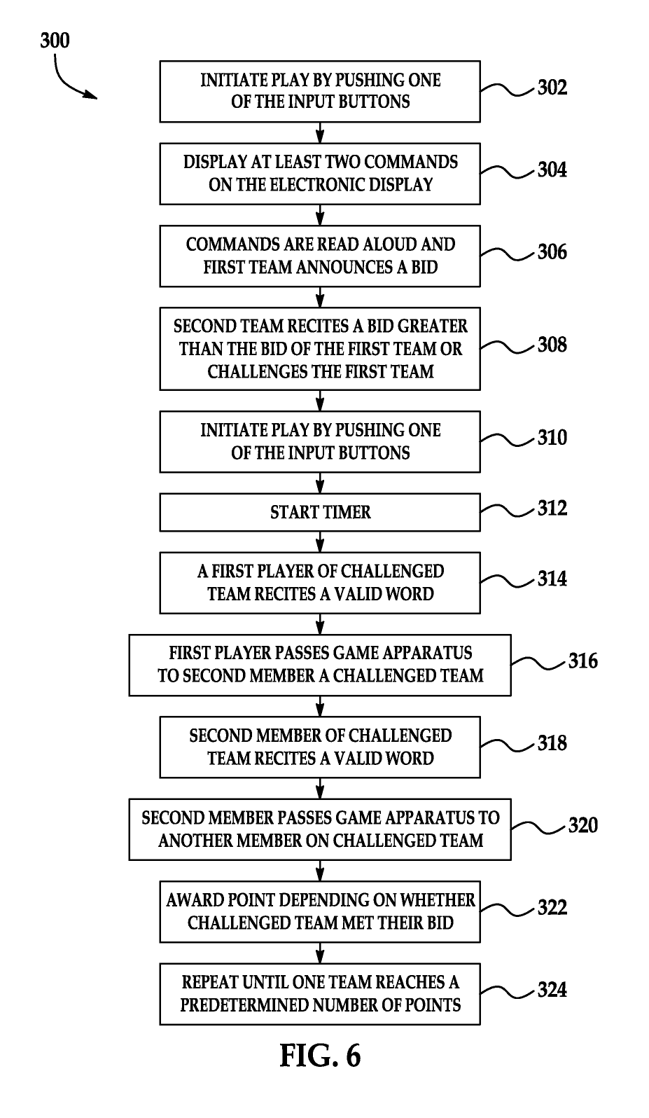

A method 300 of playing a game with the game apparatus 10 in a second mode is illustrated in FIG. 6. In block 302, after selecting the level of difficulty, a player from a first team holding the game apparatus 10 initiates play in a second play mode by pushing one of the plurality of input buttons on the game apparatus. Upon receipt of the input signal from the input button, the controller 110 sends an output signal O₁ indicative of at least two stored commands from the storage device 130 to the electronic display 60, as shown in block 304. In block 306, the player from the first team holding the game apparatus 10 reads the displayed commands out loud to all teams. The first team then announces a bid of how many valid words they believe they can speak in the given amount of time. As shown in block 308, the second team then announces a bid of the number of valid words that they believe they can speak in the given amount of time if the bid of the second team is greater than the bid of the first team. Alternatively, the second team may challenge the first team. The teams will continue to increase their bids until one of the teams is challenged.

Once a team has been challenged, as shown in block 310, a first player of the challenged team starts the game by pushing one of the input buttons 50 on the game apparatus 10. In block 312, upon receipt of the input signal I from the input button 50, the timer 120 of the controller 110 is initiated. As shown in block 314, the first player must then speak a valid word that conforms with the restrictions shown on the electronic display 60. Once a valid word is spoken, the game apparatus 10 is then passed to a second member on the challenged team, see block 316. In block 318, the second player then recites a valid word that conforms with the restrictions displayed on the electronic display 60, and then passes the game apparatus 10 in block 320 to another member of the challenged team. Such play continues until the timer 120 runs out. In block 322, the players determine whether the challenged team met their bid. If the challenged team was able to recite a number of valid words equal to or greater than the number of words they bid when they were challenged, the team will receive a point. If the challenged team was unable to recite a number of valid words greater than or equal to the number of words that they bid when challenged, the other team will receive a point. In block 324, the process is repeated until one of the teams scores a predetermined number of points, such as five points for example. The first team to reach the predetermined number of points is declared the winner.

In the preceding detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. Moreover, repeated usage of the phrase “in an embodiment” does not necessarily refer to the same embodiment, although it may. Lastly, the terms “comprising,” “including,” “having,” and the like, as used in the present application, are intended to be synonymous unless otherwise indicated. This written description uses examples to disclose the invention, including the best mode, and to enable any person skilled in the art to practice the invention, including making and using any devices or systems. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A game apparatus comprising:
a housing;
at least one input button coupled to the housing;
an electronic display coupled to the housing;
an electronic speaker coupled to the housing; and,
a controller electrically coupled to the at least one input button, electronic display and electronic speaker, the controller is responsive to executable computer instructions for initiating a timer in response to an actuation of the at least one input button and displaying a first instruction of restrictions of a valid word on the electronic display.

2. The game apparatus according to claim 1, further comprising a movable power switch coupled to a power supply.

3. The game apparatus according to claim 2, wherein the power switch is configured to movable between an off position, a first game mode position, and a second game mode position.

4. The game apparatus according to claim 1, further comprising a plurality of light sources coupled to the housing, the light sources being configured to selectively illuminate a portion of the game apparatus.

5. The game apparatus according to claim 1, wherein the controller is configured to display an additional randomly determined instruction on the electronic display after the timer is initiated.

6. The game apparatus according to claim 1, wherein the first instruction is stored in a storage device operably coupled to the controller.

7. The game apparatus according to claim 1, wherein the housing has a shape configured to facilitate grasping of the game apparatus.

8. A method for playing a game using a game apparatus comprising:
pressing an input button on the game apparatus, wherein the game apparatus includes a housing, at least one input button coupled to the housing, an electronic display coupled to the housing, and a controller electrically coupled to the at least one button;
initiating a timer and receiving a first instruction of restrictions of a valid word on the electronic display;
reciting a valid word that conforms with the first instruction of restrictions;
passing the game apparatus between players such that when each player receives the game apparatus, that player recites a valid word and again passes the game apparatus; and
eliminating a player in possession of the game apparatus when the time expires.

9. The method according to claim 8, further comprising selecting a first mode.

10. The method according to claim 9, wherein the first mode is selected by pressing the at least one input button.

11. The method according to claim 9, wherein the first mode is selected by moving a power switch to a positioned corresponding to the first mode.

12. The method according to claim 8, further comprising selecting the difficulty of the game.

13. The method according to claim 12, wherein the difficulty of the game is selected by pressing the at least one input button.

14. The method according to claim 8, wherein the method is repeated until all but one player is eliminated.

15. A method for playing a game using a game apparatus comprising:
pressing an input button on the game apparatus, wherein the game apparatus includes a housing, at least one input button coupled to the housing, an electronic display coupled to the housing, and a controller electrically coupled to the at least one input button;
viewing a first instruction of restrictions of a valid word displayed on the electronic display; wherein based on the first instruction, a first team challenges a second team to recite a predetermined number of words in a predetermined amount of time;
pressing an input button to initiate a timer such that the second team recites as many valid words as possible before the timer expires;
awarding a point to the second team if they recited at least as many words as estimated or to the first team if the second team recited fewer words than estimated.

16. The method according to claim 15, wherein the method is repeated until one of the first team or the second team accumulates a predetermined number of points.

17. The method according to claim 16, wherein whichever team accumulates the predetermined number of points first is determined to be the winner.

18. The method according to claim 15, further comprising selecting the difficulty of the game.

19. The method according to claim 18, wherein the difficulty of the game is selected by pressing the at least one input button.
